(19) United States
(12) Patent Application Publication
(10) Pub. No.: US 2025/0252327 A1
(43) Pub. Date: Aug. 7, 2025

(54) METHOD FOR SUPPORTING VERTICAL FEDERATED LEARNING AND A DEVICE PERFORMING THE SAME

(71) Applicant: Electronics and Telecommunications Research Institute, Daejeon (KR)

(72) Inventors: Jihoon SUNG, Daejeon (KR); Myung Ki SHIN, Daejeon (KR)

(73) Assignee: Electronics and Telecommunications Research Institute, Daejeon (KR)

(21) Appl. No.: 19/047,839

(22) Filed: Feb. 7, 2025

(30) Foreign Application Priority Data
Feb. 7, 2024 (KR) 10-2024-0019091
Feb. 16, 2024 (KR) 10-2024-0022868
Apr. 5, 2024 (KR) 10-2024-0046871
Apr. 25, 2024 (KR) 10-2024-0055409
May 16, 2024 (KR) 10-2024-0064053
Jun. 4, 2024 (KR) 10-2024-0073172
Aug. 9, 2024 (KR) 10-2024-0106864
Aug. 27, 2024 (KR) 10-2024-0115128
Sep. 27, 2024 (KR) 10-2024-0131835
Oct. 4, 2024 (KR) 10-2024-0134483
Oct. 23, 2024 (KR) 10-2024-0146041
Feb. 5, 2025 (KR) 10-2025-0014403

(51) Int. Cl. G06N 5/04

(52) U.S. Cl. CPC G06N 5/04

(57) ABSTRACT

Disclosed are a method of supporting vertical federated learning (VFL) and a device for performing the same. An operating method of a VFL server according to an embodiment may include determining to initiate a VFL inference procedure, selecting a VFL client to perform the VFL inference procedure using information stored in a VFL training process, and requesting the selected VFL client to perform a VFL inference.

### TECHNICAL FIELD

The following disclosure relates to a method of supporting vertical federated learning (VFL) and a device for performing the same.

### BACKGROUND OF THE INVENTION

A fifth-generation (5G) mobile communication system defined an NWDAF, which is a network function that provides functions to analyze data collected from 5G networks and provide the analytics result.

For automation and optimization of the 5G mobile communication system, NWDAF collects raw data of each network function and application function, converts the raw data into big data, and processes the big data to provide network analytics information.

The above description is information the inventor(s) acquired during the course of conceiving the present disclosure, or already possessed at the time, and is not necessarily art publicly known before the present application was filed.

### DISCLOSURE OF THE INVENTION

### Technical Goals

Embodiments provide technology for supporting vertical federated learning (VFL).

However, the technical aspects are not limited to the aforementioned aspects, and other technical aspects may be present.

### Technical Solutions

According to an aspect, there is provided an operating method of a VFL server, the operating method including determining to initiate a VFL inference procedure, selecting a VFL client to perform the VFL inference procedure using information stored in a VFL training process, and requesting the selected VFL client to perform a VFL inference.

The requesting may include transmitting a VFL inference request or a VFL inference subscription.

The request may include a user equipment identifier (UE ID) and a VFL correlation ID.

The UE ID and the VFL correlation ID may be intended to represent a VFL client that is to use a pre-trained VFL local model associated with the corresponding ID.

The operating method may further include receiving an intermediate local inference result from the selected VFL client, and generating a VFL inference result using the intermediate local inference result.

According to an aspect, there is provided a VFL server device including a processor, and a memory electrically connected to the processor and configured to store instructions executable by the processor, wherein the instructions, when executed by the processor, cause the server device to perform a plurality of operations, the plurality of operations including determining to initiate a VFL inference procedure, selecting a VFL client to perform the VFL inference procedure using information stored in a VFL training process, and requesting the selected VFL client to perform a VFL inference.

The requesting may include transmitting a VFL inference request or a VFL inference subscription.

The request may include a UE ID and a VFL correlation ID.

The UE ID and the VFL correlation ID may be intended to represent a VFL client that is to use a pre-trained VFL local model associated with the corresponding ID.

The plurality of operations may further include receiving an intermediate local inference result from the selected VFL client, and generating a VFL inference result using the intermediate local inference result.

### BRIEF DESCRIPTION OF THE DRAWINGS

FIG. 1 illustrates a network system according to an embodiment.

FIG. 2 is a diagram illustrating network data analytics according to an embodiment.

FIG. 3 is a diagram illustrating the operation of a network data analytics function (NWDAF) according to an embodiment.

FIG. 4 is a diagram illustrating the structure of an NWDAF according to an embodiment.

FIG. 5 is a diagram illustrating federated learning (FL) according to an embodiment.

FIG. 6 is a diagram illustrating vertical federated learning (VFL) according to an embodiment.

FIG. 7 is a diagram illustrating operations of a VFL server and a VFL client according to an embodiment.

FIGS. 8 to 18 are diagrams illustrating VFL procedures according to various embodiments.

FIG. 19 is a schematic block diagram of a device for supporting VFL according to an embodiment.

### BEST MODE FOR CARRYING OUT THE INVENTION

The following structural or functional description is provided as an example only and various alterations and modifications may be made to the embodiments. Here, the embodiments are not construed as limited to the disclosure and should be understood to include all changes, equivalents, and replacements within the idea and the technical scope of the disclosure.

Although terms of “first,” “second,” and the like are used to explain various components, the components are not limited to such terms. These terms are used only to distinguish one component from another component. For example, a first component may be referred to as a second component, or similarly, the second component may be referred to as the first component within the scope of the present disclosure.

When it is mentioned that one component is “connected” or “accessed” to another component, it may be understood that the one component is directly connected or accessed to another component or that still other component is interposed between the two components.

The singular forms “a”, “an”, and “the” are intended to include the plural forms as well, unless the context clearly indicates otherwise. As used herein, “A or B,” “at least one of A and B,” “at least one of A or B,” “A, B or C,” “at least one of A, B and C,” and “at least one of A, B, or C,” each of which may include any one of the items listed together in the corresponding one of the phrases, or all possible combinations thereof. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms used herein including technical or scientific terms have the same meaning as commonly understood by one of ordinary skill in the art to which examples belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

As used in connection with the present disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

The term “unit” or the like used herein may refer to a software or hardware component, such as a field-programmable gate array (FPGA) or an application-specific integrated circuit (ASIC), and the “unit” performs predefined functions. However, the term “unit” is not limited to software or hardware. A “unit” may be configured to be in an addressable storage medium or configured to operate one or more processors. Accordingly, the “unit” may include, for example, components, such as software components, object-oriented software components, class components, and task components, processes, functions, attributes, procedures, sub-routines, segments of program code, drivers, firmware, microcode, circuitry, data, databases, data structures, tables, arrays, and variables. The functionalities provided in the components and “units” may be combined into fewer components and “units” or may be further separated into additional components and “units.” Furthermore, the components and “units” may be implemented to operate on one or more central processing units (CPUs) within a device or a security multimedia card. In addition, “unit” may include one or more processors.

Hereinafter, embodiments will be described in detail with reference to the accompanying drawings. When describing the embodiments with reference to the accompanying drawings, like reference numerals refer to like components, and any repeated description related thereto will be omitted.

Herein, for ease of description, of the currently existing communication standards, terms and names defined by long-term evolution (LTE), new radio (NR), and sixth-generation (6G) standards, which are the latest standards defined by the third-generation partnership project (3GPP) association, are used. However, embodiments described hereinafter are not limited to the terms and names and a system in compliance with other standards may be applicable in the same manner.

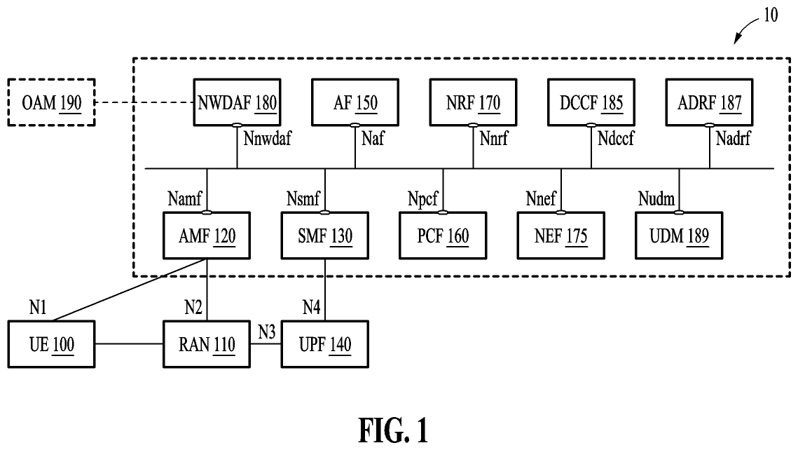

FIG. 1 illustrates a network system according to an embodiment.

Referring to FIG. 1, according to an embodiment, a network system 10 (e.g., a fifth-generation (5G) network system, a sixth-generation (6G) network system, or a 5G/6G network system) may include a plurality of entities 100 to 190. A user equipment (UE) (or a user terminal) 100 may access a 5D core network through a radio access network (RAN) 110. The RAN 110 may be a base station that provides a wireless communication function to the UE 100. An operation, administration, and maintenance (OAM) 190 may be a system for managing terminals and networks.

The unit performed by each function provided by the network system 10 may be defined as a network function (NF). The NF may include an access and mobility management function (AMF) 120, a session management function (SMF) 130, a user plane function (UPF) 140, an application function (AF) 150, a policy control function (PCF) 160, a network repository function (NRF) 170, a network exposure function (NEF) 175, a network data analytics function (NWDAF) 180, a data collection coordination function (DCCF) 185, an analytics data repository function (ADRF) 187, and a unified data management (UDM) 189. The AMF 120 may manage network access and mobility of a terminal, the SMF 130 may perform a session-related function, the UPF 140 may manage transfer of user data, and the AF 150 may perform a role to communication with a fifth-generation core (5GC) to provide an application service. The PCF 160 may manage a policy, and the NRF 170 may manage a function to store state information of NFs and process a request for finding an NF that other NFs can access.

The NWDAF 180 may analyze data collected from a network (e.g., a 5G network) and provide analytics results to support network automation. The NWDAF 180 may collect/store/analyze information from a network. The NWDAF 180 may collect information from the OAM 190, an NF forming the network (e.g., the AMF 120, the SMF 130, the UPF 140, the PCF 160, the NRF 170, the NEF 175, the DCCF 185, the ADRF 187, and/or the UDM 189), a UE, or the AF 150. The NWDAF 180 may provide the analytics results to an unspecified NF (e.g., the AMF 120, the SMF 130, the UPF 140, the PCF 160, the NRF 170, the NEF 175, the DCCF 185, the ADRF 187, and/or the UDM 189), the OAM 190, the UE, or the AF 150. The analytics results may be used independently by each NF (e.g., the AMF 120, the SMF 130, the UPF 140, the PCF 160, the NRF 170, the NEF 175, the DCCF 185, the ADRF 187, and/or the UDM 189), the OAM 190, the UE, or the AF 150.

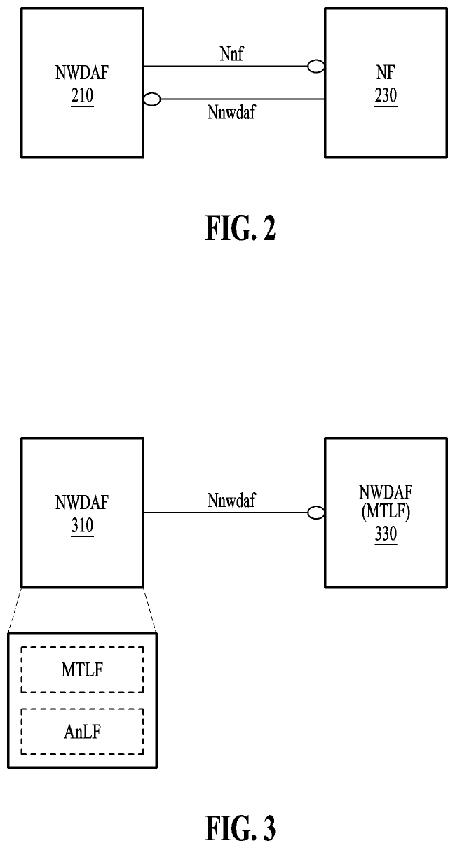

FIG. 2 is a diagram illustrating network data analytics according to an embodiment.

An NWDAF 210 (e.g., the NWDAF 180 of FIG. 1) may provide NWDAF services to an NF 230. The NWDAF services may include services such as analytics information subscription (Nnwdaf_AnalyticsSubscription), analytics information request (Nnwdaf_AnalyticsInfo), data management (Nnwdaf_DataManagement), machine learning (ML) model provisioning (Nnwdaf_MLModelProvision), ML model information request (Nnwdaf_MLModelInfo), ML model monitor (Nnwdaf_MLModelMonitor), ML model training (Nnwdaf_MLModelTraining), ML model training information request (Nnwdaf_MLModelTrainingInfo), roaming user analytics (Nnwdaf_RoamingAnalytics), and roaming data management (Nnwdaf_RoamingData). The NWDAF services provided by the NWDAF 210 may be as in Table 1.

TABLE 1

| | Service | Operation | Example |
|---|---|---|---|
| Service Name | Operations | Semantics | Consumer(s) |
| Nnwdaf_AnalyticsSubscription | Subscribe | Subscribe/ | PCF, NSSF, |
| | | Notify | AMF, SMF, |
| | | | NEF, AF, |
| | | | OAM, CEF, |
| | | | NWDAF, DCCF |
| | Unsubscribe | | PCF, NSSF, |
| | | | AMF, SMF, |
| | | | NEF, AF, |
| | | | OAM, CEF, |
| | | | NWDAF, DCCF |
| | Notify | | PCF, NSSF, |
| | | | AMF, SMF, |
| | | | NEF, AF, |
| | | | OAM, CEF, |
| | | | NWDAF, DCCF, |
| | | | MFAF |
| | Transfer | Request/ | NWDAF |
| | | Response | |
| Nnwdaf_AnalyticsInfo | Request | Request/ | PCF, NSSF, |
| | | Response | AMF, SMF, |
| | | | NEF, AF, |
| | | | OAM, CEF, |
| | | | NWDAF, DCCF |
| | ContextTransfer | Request/ | NWDAF |
| | | Response | |
| Nnwdaf_DataManagement | Subscribe | Subscribe/ | NWDAF, DCCF |
| | Notify | Notify | NWDAF, DCCF, |
| | | | MFAF, ADRF |
| | Fetch | Request/ | NWDAF, DCCF, |
| | | Response | MFAF, ADRF |
| Nnwdaf_MLModelProvision | Subscribe | Subscribe/ | NWDAF |
| | Unsubscribe | Notify | NWDAF |
| | Notify | | NWDAF |
| Nnwdaf_MLModelInfo | Request | Request/ | NWDAF |
| | | Response | |
| Nnwdaf_MLModelMonitor | Subscribe | Subscribe/ | NWDAF |
| | Unsubscribe | Notify | NWDAF |
| | Notify | | NWDAF |
| | Register | Request/ | NWDAF |
| | Request | Response | NWDAF |
| Nnwdaf_MLModelTraining | Subscribe | Subscribe/ | NWDAF |
| | Unsubscribe | Notify | NWDAF |
| | Notify | | NWDAF |
| Nnwdaf_MLModelTrainingInfo | Request | Request/ | NWDAF |
| | | Response | |
| Nnwdaf_RoamingAnalytics | Subscribe | Subscribe/ | H-NWDAF, |
| | | Notify | V-NWDAF |
| | Unsubscribe | | H-NWDAF, |
| | | | V-NWDAF |
| | Notify | | H-NWDAF, |
| | | | V-NWDAF |
| | Request | Request/ | H-NWDAF, |
| | | Response | V-NWDAF |
| Nnwdaf_RoamingData | Subscribe | Subscribe/ | H-NWDAF, |
| | | Notify | V-NWDAF |
| | Unsubscribe | | H-NWDAF, |
| | | | V-NWDAF |
| | Notify | | H-NWDAF, |
| | | | V-NWDAF |

NOTE 1:
How OAM consumes Nnwdaf services and which Analytics information is relevant is defined in TS 28.550 Annex H and out of the scope of this TS.
NOTE 2:
How CEF consumes Nnwdaf services and which Analytics information is relevant is defined in TS 28.201 and out of the scope of this TS.)
NOTE 3:
The Nnwdaf_MLModelProvision service Nnwdaf_MLModelInfo service are provided by an NWDAF containing MTLF and consumed by an NWDAF containing AnLF.

The NWDAF 210 may perform analytics in response to a request from the NF 230, and provide analytics information (e.g., analytics results) to the NF 230

Hereinafter, among the services of Table 1, the analytics information subscription service (Nnwdaf_AnalyticsSubscription service) and the analytics information request service (Nnwdaf_AnalyticsInfo service) are described in detail.

The NWDAF 210 (e.g., the NWDAF 180 of FIG. 1) may provide the analytics information subscription service (Nnwdaf_AnalyticsSubscription service) to the NF 230. The analytics information subscription service may enable subscription and unsubscription of network data analytics information (or network data analytics results) generated by the NWDAF 210. The analytics information subscription service may receive network analytics information (or network analytics results) periodically according to the need of a network function of the NF 230 subscribing to the service or receive network analytics information (or network analytics results) if a predetermined condition is satisfied. The analytics information subscription service may be provided through three operations of subscription, unsubscription, and notification.

The subscription operation (Nnwdaf_AnlayticsSubscription_Subscribe operation) may include a required input and/or an optional input. The required input may include single network slice selection assistance information (S-NSSAI), an event identifier or analytics ID (or analytics information ID), a notification target address, and event reporting information. The optional input may include information additionally required to process the analytics information. For example, the optional input may include an event filter or an analytics filter (or an analytics information filter). Of course, the embodiments are not limited to the above examples.

In the unsubscription operation (Nnwdaf_AnlayticsSubscription_Unsubscribe operation), the NF 230 may transmit the subscription identifier information to the NWDAF 180, and the NWDAF 210 may transmit, as output, a message informing that unsubscription has been confirmed, to the NF 230 that requested unsubscription.

In the notification operation (Nnwdaf_AnlayticsSubscription_Notify operation), the NWDAF 210 may notify the NF 230 successfully subscribing to the analytics information subscription service of designated network data analytics information (or network data analytics results) periodically or when a predetermined condition is satisfied. The notification operation may include an event identifier or analytics ID (or analytics information ID), and a notification target address.

The NWDAF 210 may provide the analytics information request service (Nnwdaf_AnalyticsInfo service) to the NF 230. The analytics information request service, unlike the analytics information subscription service, may be a service for the NF 230 to request analytics regarding predetermined information and receive result values immediately when the request is completed. The operation of the analytics information request service may include a request and a response. The NF 230 requesting analytics information may transmit an analytics information request message (e.g., Nnwdaf_AnalyticsInfo_Request service operation) to the NWDAF 180.

The NWDAF 210 may transmit the analytics information to each NF 230 requesting the analytics information. The analytics information may be used to optimize the performance of an operation (or a network function) performed by each NF 230 (e.g., congestion control, Quality of Service (QOS) management, traffic control, mobility management, load dispersion, or terminal power control).

The NF 230 (e.g., the UE 100, the RAN 110, the AMF 120, the SMF 130, the UPF 140, the AF 150, the PCF 160, the NRF 170, the NEF 175, the DCCF 185, the ADRF 187, and/or the OAM 190 of FIG. 1) may become a consumer NF requesting analytics results from the NWDAF 210. Each NF 230 may become a service consumer NF of the network data analytics service. The NWDAF 210 may collect data from each NF 230 and analyze the data to generate the analytics information requested by the consumer NF. The NWDAF 210 may transmit the analytics information to the consumer NF transmitting the analytics request. Accordingly, the NWDAF 210 may become a provider NF of the analytics results requested by the consumer NF. The NWDAF 210 may become a service provider NF of a service to provide the analytics information requested by the service consumer NF.

The NWDAF 210 may include one or more of an analytics logical function (AnLF) and a model training logical function (MTLF). The NWDAF 210 may include either the MTLF or the AnLF or may support both.

An NWDAF (e.g., the NWDAF 210) including the AnLF may perform inference and derive analytics information (e.g., derive statistics and/or predictions according to an analytics consumer request). The NWDAF including the AnLF may expose an analytics service for network data (e.g., Nnwdaf_AnalyticsSubscription or Nnwdaf_AnalyticsInfo).

An NWDAF (e.g., the NWDAF 210) including the MTLF may train an ML model, and expose a new training service (e.g., provide the initial version that is not trained or a trained model).

FIG. 3 is a diagram illustrating the operation of an NWDAF according to an embodiment.

An NWDAF 310 may use a provisioning service task and a training service task for an ML model of an initial model not trained by an NWDAF 330 or a trained ML model. The NWDAF 310 may include one or more of an AnLF and an MTLF, and the NWDAF 330 may include an MTLF.

The AnLF may perform inference and derive analytics information (e.g., derive statistics and/or predictions according to an analytics consumer request), and expose an analytics service (e.g., Nnwdaf_AnalyticsSubscription or Nnwdaf_AnalyticsInfo). The MTLF may train an ML model, and expose a new training service (e.g., provide the trained ML model and train the ML model).

The AnLF may support a data analytics information service (e.g., Nnwdaf_AnalyticsInfo) or an analytics subscription service (e.g., Nnwdaf_AnalyticsSubscription). The MTLF may support services such as an ML model provisioning service (e.g., Nnwdaf_MLModelProvision), an ML model information request service (e.g., Nnwdaf_MLModelInfo), an ML model training service (e.g., Nnwdaf_MLModelTraining), and an ML model training information service (e.g., Nnwdaf_MLModelTrainingInfo).

An Nnwdaf interface may be used to request and subscribe to an untrained initial version or trained ML model provisioning service. The Nnwdaf interface may be used to request and subscribe to an ML model training service for ML model training and federated learning (FL).

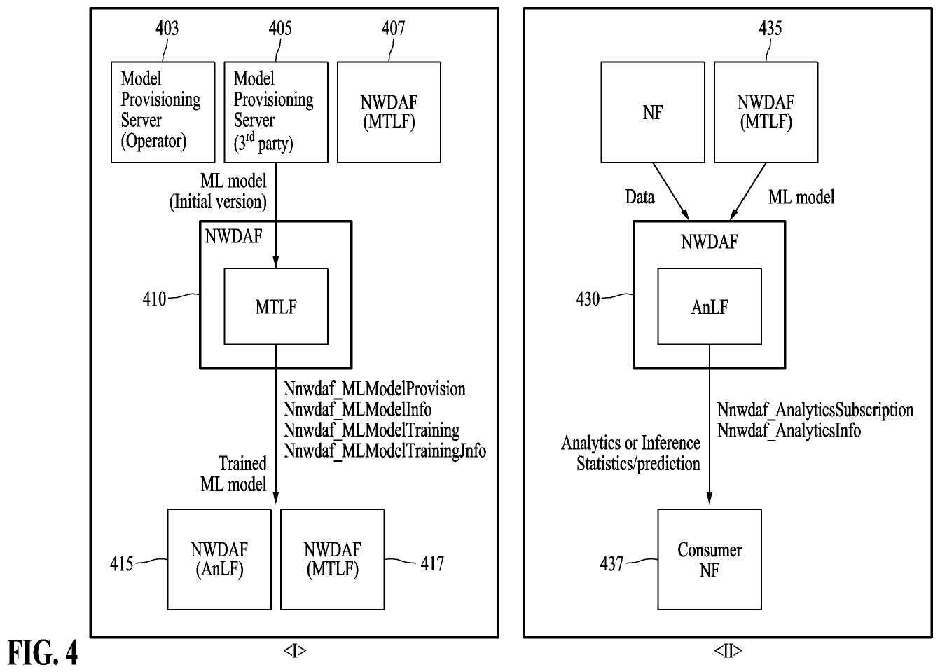

FIG. 4 is a diagram illustrating the structure of an NWDAF according to an embodiment.

The operation of an NWDAF 410 including an MTLF is described with reference to I of FIG. 4. The NWDAF 410 may receive the initial version of an ML model from a model provisioning server (operator) 403, a model provisioning server (3rd party) 405, or another NWDAF 407 including an MTLF. Thereafter, the NWDAF 410 may train based on the initial version of the ML model and then, provide the trained ML model to an NWDAF 415 including an AnLF or an NWDAF 417 including an MTLF through an ML model provisioning service (e.g., Nnwdaf_MLModelProvision service) or an ML model information service (e.g., Nnwdaf_MLModelInfo service). Further, to update the ML model, the NWDAF 410 may use an Nnwdaf_MLModelTraining or Nnwdaf_MLModelTrainingInfo service.

The operation of an NWDAF 430 including an AnLF is described with reference to II of FIG. 4. The NWDAF 430 may collect data from a DCCF device and/or a data source (e.g., an NF or an ADRF). The NWDAF 430 may receive an ML model from an NWDAF 435 including an MTLF. The NWDAF 430 may analyze the collected data using the ML model. The NWDAF 430 may provide the data analytics results to a consumer NF device 437 in the manner of statistics or predictions.

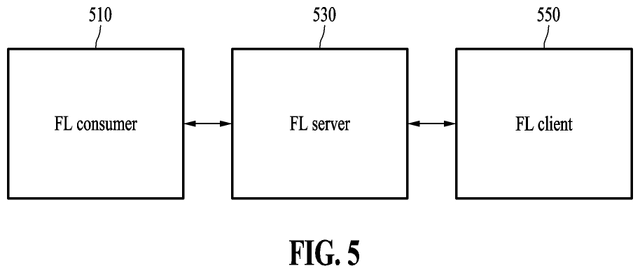

FIG. 5 is a diagram illustrating FL according to an embodiment.

An FL consumer 510, an FL server 530, and an FL client 550 may be involved in FL. For example, the FL consumer 510, the FL server 530, and the FL client 550 may be different NWDAFs. The FL consumer 510 may be an NWDAF including an AnLF or an NWDAF including an MTLF (e.g., an MTLF without an “FL server” capability). The FL server 530 may be an NWDAF including an MTLF. The FL client 550 may be an NWDAF including an MTLF. One or more of the FL consumer 510, the FL server 530, and the FL client 550 may be NWDAF(s), and the rest may be NF(s) other than NWDAF(s). The FL consumer 510, the FL server 530, and the FL client 550 may be different NFs, excluding NWDAFs.

The FL consumer 510 or the FL client 550 may perform FL. For FL, the services in Table 1 may be supported among the FL consumer 510 or the FL client 550. For example, the FL consumer 510 or the FL client 550 may perform FL using services such as ML model provisioning (Nnwdaf_MLModelProvision), ML model information request (Nnwdaf_MLModelInfo), ML model monitor (Nnwdaf_MLModelMonitor), ML model training (Nnwdaf_MLModelTraining), and ML model training information request (Nnwdaf_MLModelTrainingInfo).

For ease of description, it may be assumed that the FL consumer 510, the FL server 530, and the FL client 550 are implemented as different NWDAFs. FL among multiple NWDAFs may train an ML model across multiple distributed entities holding local datasets without exchanging/sharing the local datasets. Horizontal federated learning (HFL) is supported among multiple NWDAFs, and thus, the local dataset in different FL client NWDAFs may have the same feature space for different samples (e.g., UE IDs). In FL, the FL consumer 510 may be an “FL consumer” NWDAF, the FL server 530 may be an “FL server” NWDAF, and the FL client 550 may be an “FL client” NWDAF. Hereinafter, the “FL consumer” NWDAF, the “FL client” NWDAF, and the “FL server” NWDAF are described.

An NWDAF including an MTLF (e.g., the FL consumer 510, the FL server 530, and/or the FL client 550) may be registered to an NRF (e.g., the NRF 170 of FIG. 1). For example, the NWDAF including the MTLF may register its NF profile to the NRF. The NWDAF including the MTLF may include an “FL capability” in the NF profile registered in the NRF (e.g., the NRF 170 of FIG. 1).

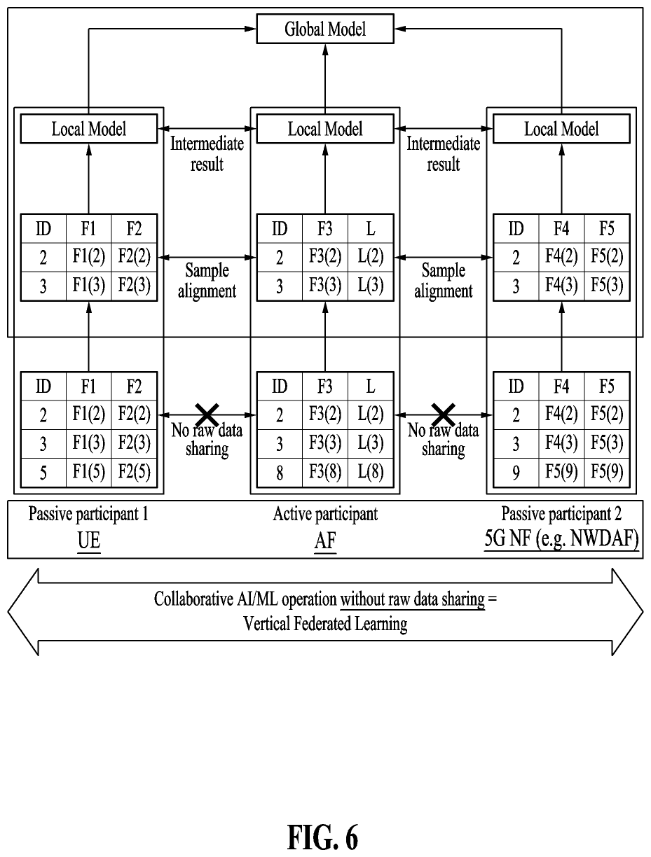

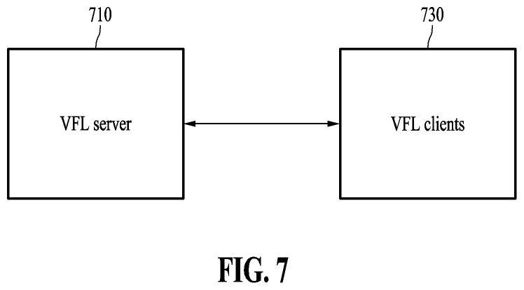

The “FL capability” may indicate that an “FL server” capability and/or an “FL client” capability is supported for the corresponding Analytics ID. Further, the “FL capability” may indicate the Nnwdaf_MLModelTraining service and/or the Nnwdaf_MLModelTrainingInfo service are supported (e.g., see FIGS. 6 and 7).

The “FL server” capability may indicate that the MTLF can manage an FL operation (or task), select an FL client, aggregate ML models from other ML clients (e.g., “FL consumer” NWDAFs and/or “FL client” NWDAFs), send the trained ML model information back to the FL client, and if the accuracy of the ML model meets a predetermined condition, send the model back from the FL consumer.

The “FL client” capability may indicate that the MTLF can perform ML model training on an ML model requested by the “FL server” using available local data and local NFs, and report the trained ML model information to the “FL server”. The local data may be data that the MTLF is allowed to collect from another 5GS or ADRF.

The “FL consumer” NWDAF (e.g., the FL consumer 510) may be an NWDAF including an AnLF or an NWDAF including an MTLF. The “FL consumer” NWDAF may request the “FL server (FL Server)” NWDAF to perform FL, thereby enabling FL for an ML model (e.g., its own ML model and/or a downloaded (or received) ML model and/or an ML model to be downloaded (or received)).

The “FL server” NWDAF (e.g., the FL server 530), as an NWDAF including an MTLF, may support the “FL server” capability for a predetermined analytics ID and be selected as an “FL server”. The “FL server” NWDAF may be selected based on the local configuration of an operator or selected by a consumer (or analytics consumer, or service consumer) NWDAF for the analytics ID.

The “FL client” NWDAF (e.g., the FL client 550), as an NWDAF including an MTLF, may support the “FL client” function for a predetermined analytics ID and be selected as an FL client by the “FL server” NWDAF (e.g., the FL server 530).

If the “FL consumer” NWDAF is an NWDAF including an MTLF and determines an FL trigger based on internal logic (e.g., lack of data for training, excessive overhead of existing ML training, etc.), the “FL consumer” NWDAF may discover an NWDAF supporting the “FL server” capability through an NRF, and initiate FL by calling an Nnwdaf_MLModelTraining_Subscribe operation along with the indication of enabling FL and the initial ML model file address using the selected NWDAF (e.g., the “FL server” NWDAF).

The “FL server” NWDAF may discover and select the “FL client” NWDAF. For example, the “FL server” NWDAF may select the “FL client” NWDAF from the NRF. The “FL server” NWDAF may additionally include the number of NWDAFs reported for the analytics ID and the “FL client” capability as the “FL client” capability in a discovery request message. The NRF may return candidates for instances of the NWDAF including the MTLF, and each candidate for an instance of the NWDAF including the MTLF may include analytics ID, ML model filter information, and “FL client” support for the analytics ID.

The “FL server” NWDAF may request the “FL client” NWDAF to perform local model training and report local model information. The “FL server” NWDAF may generate a global ML model by aggregating the local model information from the “FL client” NWDAF. The “FL server” NWDAF may send the global ML model back to the FL client NWDAF to perform an additional training iteration if needed. The “FL client” NWDAF may locally train the ML model with a local dataset that is not used by the “FL server” NWDAF. The local dataset may include data that is not allowed to be shared with other “FL client” NWDAFs due to data privacy, data security, or data access rights. The “FL client” NWDAF may report the trained local ML model information to the “FL server” NWDAF. The “FL client” NWDAF may receive the global ML model from the “FL server” NWDAF, and perform an additional training iteration if needed.

When the FL consumer 510 as the “FL consumer” NWDAF requests the FL server 530 as the “FL server” NWDAF to perform FL, the FL server 530 may support the “FL client” NWDAF discovery procedure, and support transmitting an FL request to the “FL client” NWDAF. Further, the FL server 530 may support aggregation of intermediate training results from the “FL client” NWDAF.

The FL client 550 as the “FL client” NWDAF may support local ML training based on the FL request received from the FL server 530 as the “FL server” NWDAF, and support reporting the trained intermediate ML model to the FL server 530.

FIG. 6 is a diagram illustrating vertical federated learning (VFL) according to an embodiment.

FIG. 6 shows an example of implementing a VFL framework in a 5GC. Raw data collection from other NF(s), UE(s), and/or OAM is not possible due to reasons such as data privacy concerns.

A system model of VFL may be as in the example shown in FIG. 6. Participants in VFL may be divided into active participants and passive participants. The active participants may be participants that own data labels for training, while the passive participants may be participants that contribute to training without possessing data labels. It is assumed that all participants (e.g., active participants and/or passive participants) do not exchange their raw data with other participants, but they may exchange intermediate results. Additionally, it may be assumed that participants have data with different features for the same samples.

Before training, each participant may need a local model for training. The local model may be provided by an active participant or a third-party entity. The active participant may play a role in managing a model (e.g., a local model). In other cases, a third-party entity may manage a model. An entity playing a role in managing a model may be referred to as a VFL server. Although FIG. 6 depicts the active participant owning a global model, the global model may be owned by other participants or a third-party entity depending on the embodiment. The global model may be the entirety or part of a full model, distinct from a local model in each participant.

Each participant may own a different combination of data. For example, a passive participant 1 (e.g., UE of FIG. 6) may own data for IDs 2, 3, and 5, a passive participant 2 (e.g., 5G NF of FIG. 6) may own data for IDs 2, 3, and 9, and the active participant (e.g., AF of FIG. 6) may own data for IDs 2, 3, and 8. In FIG. 6, each data may include multiple features for a predetermined ID, denoted as F1 (ID), F2 (ID), and/or F3 (ID). The active participant may own data labels, represented by “L” in the table, which is different from the passive participants. In the VFL scheme, privacy preservation without sharing raw data may be crucial. It is challenging to determine whether participants have data with different features for the same samples, which is a VFL requirement. In this context of VFL, a sample alignment process may be required to align samples among participants involved in training for the same task. Private set intersection (PSI) is a common method for privacy-preserving alignment, and may determine whether there are the same samples among participants by comparing intersections among their data in a private manner. In FIG. 6, all participants may own data for IDs 2 and 3, enabling the selection of data for training through the sample alignment process.

After the sample alignment, each participant may train a local model with its local data and transmit the training results to the VFL server. The training results may also be referred to as intermediate results. The intermediate results may include local model outputs and corresponding gradients. The VFL server may compute the gradients of its global model and update models accordingly to the computation results. For example, the VFL server may update the global model and/or the local model. Further, the VFL server may compute the gradients for each participant (e.g., the gradients of a local model derived by each participant) and send the gradients back to each participant.

FIG. 7 is a diagram illustrating operations of a VFL server and a VFL client according to an embodiment.

VFL is to train an ML model without explicitly sharing raw data among participants involved in training and/or inference. VFL may be performed between a VFL server 710 and one or more VFL clients 730. The VFL server 710 may be a VFL active participant that owns label information, while the VFL clients 730 may be VFL passive participants involved in the training process without owning labels. To support VFL, the VFL server 710 and the VFL clients 730 may operate as follows.

The VFL server 710 may:
own labels (e.g., data labels) for a task and coordinate the training and inference procedures,
distribute initial ML models to each VFL client 730,
discover and select VFL clients 730 to participate in a VFL procedure,
request the VFL clients 730 to perform local model training and to report local intermediate information (e.g., intermediate results),
locally train an ML model with an available local dataset,
compute a training loss and gradients by aggregating local intermediate information (e.g., intermediate results) from the VFL clients 730, and
send the gradients back to the VFL clients 730 to perform an additional training iteration if needed.

The VFL clients 730 may:
locally train an ML model (e.g., a local model) as tasked by the VFL server 710 with an available local data set,
report the trained local intermediate information to the VFL server 710, and
receive gradient information from the VFL server 710 and compute the gradient of the local model.

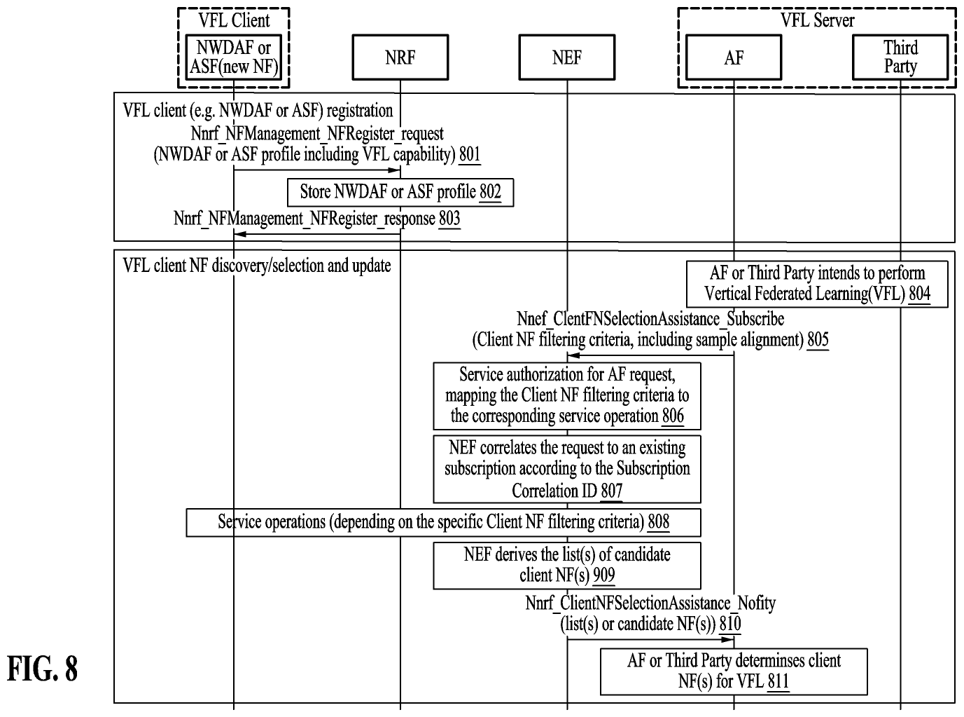

FIGS. 8 to 18 are diagrams illustrating VFL procedures according to various embodiments. Hereinafter, embodiments are described with reference to FIGS. 8 to 18.

FIGS. 8 to 10 illustrate a VFL scenario where an AF or a third party is a VFL server while an NWDAF is a VFL client.

FIG. 8 is a diagram illustrating a VFL procedure according to an embodiment.

FIG. 8 illustrates a procedure for VFL client registration and a VFL client discovery and selection procedure in the VFL procedure. The procedure for VFL client registration may include operations 801 to 803, and the VFL client discovery and selection may include operations 804 to 811.

In operation 801, an NWDAF or ASF (e.g., a new NF supporting the AI/ML function) with the capability to participate as a VFL client may register its NF profile with an NRF. For example, the NWDAF or ASF may register the NF profile with the NRF through Nnrf_NFManagement_NFRegister_request. The NF profile may include VFL capability information indicating whether it can support training for VFL, VFL capability type information (e.g., VFL server or VFL client), the NWDAF NF type, analytics ID(s), address information of NWDAF, service area, and time interval supporting VFL. If the NWDAF is a VFL client, the NWDAF may include the functionality to perform ML model training with ML models provided by the AF or third party, serving as a VFL server.

In operation 802, the NRF may store the profile of the NWDAF or ASF (e.g., the NF profile) and mark the profile as available.

In operation 803, the NRF may acknowledge that NF registration is accepted via Nnrf_NFManagement_NFRegister_response.

In operation 804, the VFL server (e.g., the AF or third party) may aim to perform VFL. If the third party plays a role of a VFL server, the third party may communicate with a 5GC through the AF. If the AF serves as a VFL server without involving the third party, the AF may directly communication with the 5GC.

In operation 805, the VFL server (e.g., the AF) may subscribe to VFL client NF selection assistance information by sending an initial Nnef_ClientNFSelectionAssistance_subscribe request to the NEF. The initial Nnef_ClientNFSelectionAssistance_subscribe request may include one or more VFL client NF filtering criteria. Subsequently, the AF may update the client NF filtering criteria of the subscription by invoking Nnef_ClientNFSelectionAssistance_subscribe and providing a subscription correlation ID. In operation 805, filtering criteria related to sample and/or feature alignment or the VFL capability may be included. For example, the Nnef_ClientNFSelectionAssistance_subscribe request may include the filtering criteria related to sample and/or feature alignment or the VFL capability.

In operation 806, if the AF request (e.g., Nnef_ClientNFSelectionAssistance_subscribe request) does not include a subscription correlation ID, the NEF may verify the authorization of the AF request and execute the corresponding service task (e.g., NF discovery) based on the VFL client NF filtering criteria provided by the AF. If filtering criteria related to sample and/or feature alignment are included in operation 805, the NEF may perform operations necessary for sample and/or feature alignment. For example, the NEF may identify a set of available NFs that have data for the same sample but different features based on the received filtering criteria.

Sample and/or feature alignment may be performed by other NFs (e.g., NWDAFs) as well as the NEF.

In operation 807, if the AF request (e.g., Nnef_ClientNFSelectionAssistance_subscribe request) includes a subscription correlation ID, the NEF may update the Nnef_ClientNFSelectionAssistance_Subscribe request to an existing subscription based on the subscription correlation ID. The NEF may update the filtering criteria and subsequently trigger corresponding service operations (e.g., NF discovery) based on the updated filtering criteria.

In operation 808, the NEF may interact with different 5GC NFs to collect the required information. The interactions between the NEF and the 5GC NFs may depend on the VFL client NF filtering criteria provided by the AF.

In operation 809, based on the collected information from the other 5GC NFs, the NEF may consolidate all the information to derive a list of candidate NFs that fulfil the VFL client NF filtering criteria in the AF request.

In operation 810, the NEF may transmit an Nnef_ClientNFSelectionAssistance_Notify to the AF. The Nnef_ClientNFSelectionAssistance_Notify may include the list of candidate NFs and additional information.

Operations 805 to 810 may be replaced by alternative service operations, and the task of selecting candidate VFL clients may be performed by NFs other than the NEF. Additionally, the VFL server may directly handle the selection of candidate VFL clients.

In operation 811, the VFL server may determine VFL client NF(s) based on the information received in operation 810.

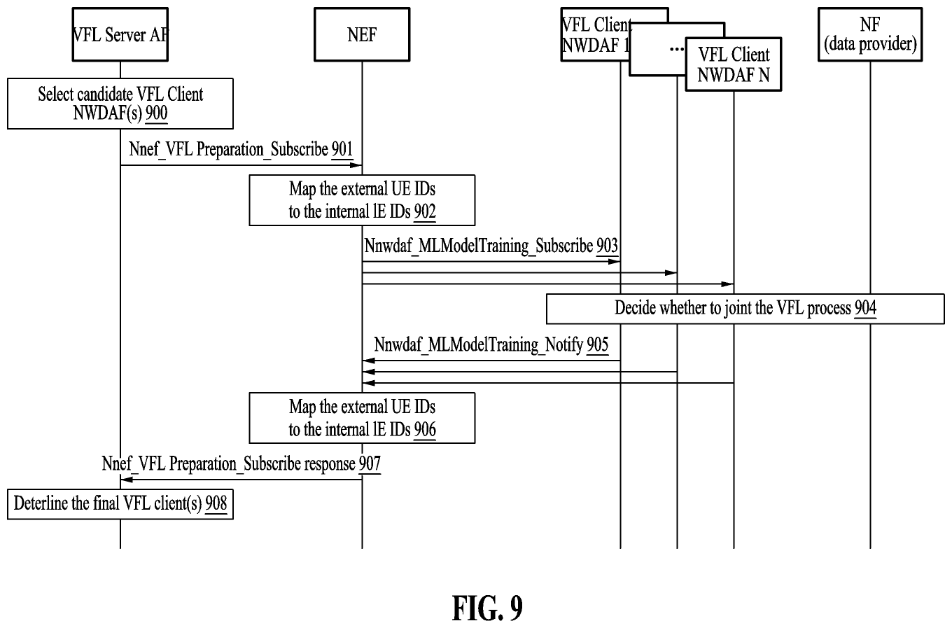

FIG. 9 is a diagram illustrating a VFL procedure according to an embodiment.

FIG. 9 illustrates a preparation (including sample alignment) procedure in the VFL procedure, and specifies the preparation procedure for AF-initiated VFL scenarios between an AF and NWDAF(s) within a single public land mobile network (PLMN).

In operation 900, an AF as a VFL server may discover and select candidate VFL clients through the discovery procedure.

In operations 901 to 903, the AF as the VFL server may transmit a VFL preparation request to the candidate VFL clients with an ML preparation flag. The AF as the VFL server may check if the VFL clients can meet the ML model training requirements (e.g., analytics ID, ML model interoperability information, sample alignment requirements, data availability requirements, and/or VFL availability time requirements (e.g., the time span needed for the VFL process)). A trusted AF may perform this directly using a service for an ML model (e.g., an Nnwdaf_MLModelTraining_Subscribe or Nnwdaf_MLModelTrainingInfo_Request service). The Nnwdaf_MLModelTraining_Subscribe or Nnwdaf_MLModelTrainingInfo_Request service is merely an example of the service for the ML model, and depending on the embodiment, various services for the ML model may be used in lieu of the Nnwdaf_MLModelTraining_Subscribe or Nnwdaf_MLModelTrainingInfo_Request service, and the service operation name may also vary depending on the embodiment. The sample alignment requirements may include a list of samples targeted for VFL training as defined by the AF. The data availability requirements may include a list of event IDs of the local data necessary for training. The data availability requirements and/or the list of event IDs may be used to ensure different features for the same samples across each involved NF in the context of VFL feature alignment. The data availability requirements may also include the dataset statistical properties, the time window of the data samples, and the minimum number of data samples. The NEF may be only involved for an untrusted AF and map the external UE IDs (e.g., generic public subscription identifiers (GPSIs)) to the internal UE IDs (e.g., subscription permanent identifiers (SUPIs)).

In operation 904, the VFL client(s) may check if it can meet the ML model training requirements and determine whether to join the VFL process based on operator policy and/or implementation. Example criteria used by the VFL client(s) may be based on whether it can satisfy the sample alignment requirements, its data availability, and time availability, and ML model interoperability information.

In operations 905 to 907, the VFL client(s) may invoke directly an Nnwdaf_MLModelTraining_Notify, Nnwdaf_MLModelTraining_Subscribe response, or Nnwdaf_MLModelTrainingInfo_Request response service operation for a trusted AF, or indirectly via the NEF Nnef_VFLPreparation_Subscribe response service operation for an untrusted AF to indicate to the VFL server whether it will join the VFL process. The response may include a reason if it cannot join the VFL process.

In operation 908, the VFL server may determine the final VFL client to be involved in the VFL process based on the information received in operation 806 of the previous discovery procedure and other information available from operation 907.

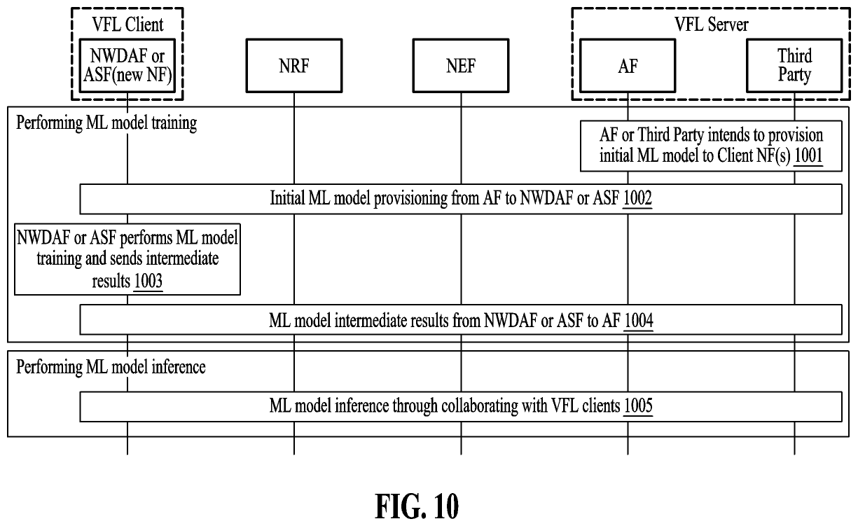

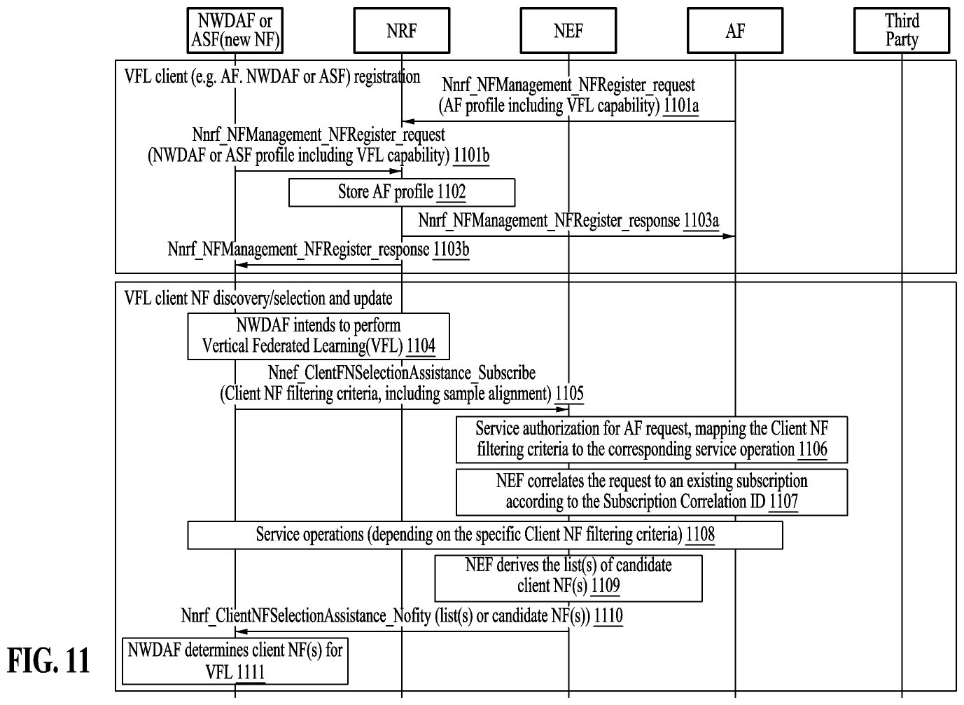

FIG. 10 is a diagram illustrating a VFL procedure according to an embodiment.

FIG. 10 illustrates an ML model provisioning procedure, an ML model training procedure, and an ML model inference procedure in the VFL procedure. The ML model provisioning procedure and the ML model training procedure may include operations 1001 to 1004, and the ML model inference procedure may include operation 1005.

In operation 1001, a VFL server (e.g., an AF or a third party) may provision an initial ML model for VFL to a VFL client (or VFL client NF) (e.g., an NWDAF and/or an ASF).

The VFL server may own the entire ML model for VFL. Depending on the embodiment, the ownership of the entire ML model may vary depending on scenarios, and the relevant procedures may be updated accordingly.

In operation 1002, the VFL server (e.g., the AF or the third party) may provision an initial ML model used for training to the NWDAF or the ASF selected as the VFL client NF.

In operation 1003, the VFL client (e.g., the NWDAF or the ASF) may perform ML model training based on the provisioned initial ML model in operation 1002 and a local dataset.

In operation 1004, the VFL client (e.g., the NWDAF or the ASF) may transmit intermediate results of training to the VFL server (e.g., the AF or the third party).

In operation 1005, the ML model inference may be performed collaboratively with the VFL server and the VFL client.

FIGS. 11 to 13 illustrate scenarios where an NWDAF is a VFL server while another NWDAF, an AF and/or a third party are VFL clients.

FIG. 11 is a diagram illustrating a VFL procedure according to an embodiment.

FIG. 11 illustrates a procedure for VFL client registration and a VFL client discovery and selection procedure in the VFL procedure. The procedure for VFL client registration may include operations 1101a to 1103b, and the procedure for VFL client discovery and selection may include operations 1104 to 1111.

In operation 1101a, AF(s) with the capability to participate as VFL clients may register its NF profile with an NRF. For example, the AF(s) may register its NF profile with the NRF through Nnrf_NFManagement_NFRegister_request. The NF profile may include VFL capability information indicating whether it can support training for VFL, VFL capability type information (e.g., a VFL server or a VFL client), the NWDAF NF type, analytics ID(s), address information of NWDAF, service area, and time interval supporting VFL. It requires the AF(s) to have the capability to perform ML model training with ML models provided by an NWDAF, serving as a VFL server, as a new functionality.

In operation 1101b, an NWDAF or ASF (e.g., a new NF supporting the AI/ML function) with the capability to participate as a VFL client may register its NF profile with the NRF. For example, the NWDAF or ASF may register its NF profile with the NRF through Nnrf_NFManagement_NFRegister_request. The NF profile may include VFL capability information indicating whether it can support training for VFL, VFL capability type information (e.g., a VFL server or a VFL client), the NWDAF NF type, analytics ID(s), address information of NWDAF, service area, and time interval supporting VFL.

In operation 1102, the NRF may store the NF profile (e.g., AF(s), NWDAF(s), and/or ASF profile) and mark the NF profile as available.

In operations 1103a and 1103b, the NRF may acknowledge that NF registration is accepted via Nnrf_NFManagement_NFRegister_response.

In operation 1104, the NWDAF or ASF, serving as a VFL server, may aim to perform VFL.

In operation 1105, the NWDAF or ASF may subscribe to the VFL client NF selection assistance information by sending an initial Nnef_ClientNFSelectionAssistance_subscribe request to the NEF. The initial Nnef_ClientNFSelectionAssistance_subscribe request may include one or more VFL client NF filtering criteria. Subsequently, the NWDAF or ASF may update the client NF filtering criteria of the subscription by invoking Nnef_ClientNFSelectionAssistance_subscribe and providing a subscription correlation ID. In operation 1105, filtering criteria related to sample and/or feature alignment or VFL capability may be included. For example, the Nnef_ClientNFSelectionAssistance_subscribe request may include the filtering criteria related to sample and/or feature alignment or the VFL capability.

In operation 1106, if the NWDAF or ASF request (e.g., the Nnef_ClientNFSelectionAssistance_subscribe request) does not include a subscription correlation ID, the NEF may verify the authorization of the NWDAF or ASF request and execute the corresponding service task (e.g., NF discovery) based on the VFL client NF filtering criteria provided by the NWDAF or ASF. If filtering criteria related to sample and/or feature alignment are included in operation 1105, the NEF may perform operations necessary for sample and/or feature alignment. For example, the NEF may identify a set of available NFs that have data for the same sample, but different features based on the received filtering criteria.

Sample and/or feature alignment may be performed by other NFs (e.g., an NWDAF and/or ASF) as well as the NEF.

In operation 1107, if the NWDAF or ASF request includes a subscription correlation ID, the NEF may update the Nnef_ClientNFSelectionAssistance_Subscribe request to an existing subscription based on the subscription correlation ID. The NEF may update the filtering criteria and subsequently trigger corresponding service operations (e.g., NF discovery) based on the updated filtering criteria.

In operation 1108, the NEF may interact with different 5GC NFs to collect the required information. The interactions between the NEF and the 5GC NFs may depend on the VFL client NF filtering criteria provided by the NWDAF or ASF.

In operation 1109, based on the collected information from other 5GC NFs, the NEF may consolidate all the information to derive a list of candidate NFs that fulfil the VFL client NF filtering criteria in the NWDAF or ASF request.

In operation 1110, the NEF may an transmit Nnef_ClientNFSelectionAssistance_Notify request to the NWDAF or ASF. The Nnef_ClientNFSelectionAssistance_Notify may include the list of candidate NFs and additional information.

Operations 1105 to 1110 may be replaced by alternative service operations, and the task of selecting candidate VFL clients may be performed by NFs other than the NEF. Additionally, the VFL server may directly handle the selection of candidate VFL clients.

In operation 1111, the NWDAF may determine VFL client NF(s) based on the information received in operation 1110.

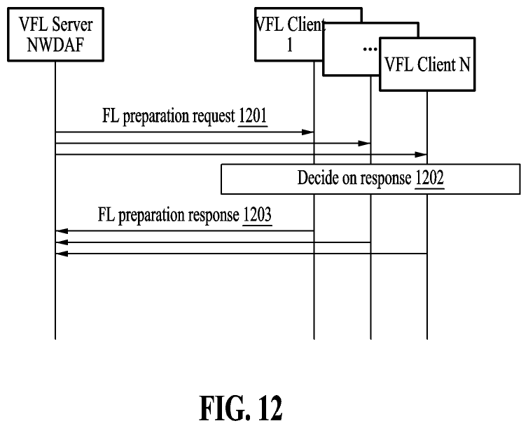

FIG. 12 is a diagram illustrating a VFL procedure according to an embodiment.

FIG. 12 illustrates a procedure of preparation (including sample alignment) in the VFL procedure.

In operation 1201, an NWDAF, as a VFL server, may transmit a VFL preparation request to candidate VFL client(s) with an ML preparation flag, via an Nnwdaf_MLModelTraining_Subscribe or Nnwdaf_MLModelTrainingInfo_Request service. The NWDAF, as the VFL server, may include a list of sample ID(s), analytics ID(s), and optionally feature ID(s) in the VFL preparation request.

In operation 1202, each VFL client may check if it can meet the ML model training requirements. If it is impossible to meet the requirements due to some reasons, the requirements that the corresponding VFL client can meet may be determined.

In operation 1203, each VFL client may invoke an Nnwdaf_MLModelTraining_Notify or Nnwdaf_MLModelTraining_Subscribe response or an Nnwdaf_MLModelTrainingInfo_request response service operation to indicate to the VFL server whether it accepts the requirements, whether new requirements are requested, or whether to join the VFL task. If the corresponding VFL client cannot join the VFL procedure, the reason may be included as a parameter of the corresponding service operation, or acceptable requirements may be included. If new requirements are included in the corresponding notify or response, it may be repeated from operation 1201.

In operation 1204, the VFL server NWDAF may determine VFL client(s) based on the information received in operation 1203 and the information received in operation 1110 associated with VFL client discovery and selection described with reference to FIG. 11.

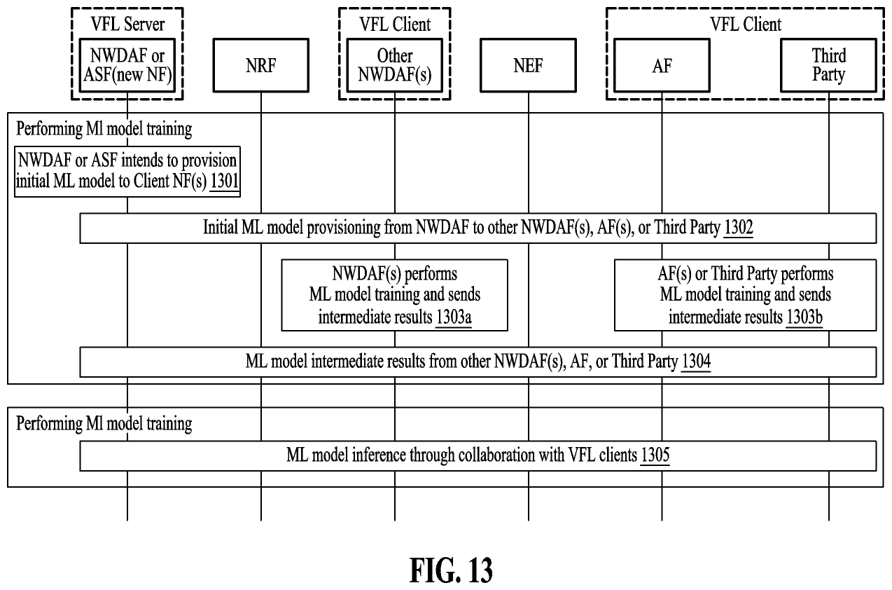

FIG. 13 is a diagram illustrating a VFL procedure according to an embodiment.

FIG. 13 illustrates an ML model provisioning procedure, an ML model training procedure, and an ML model inference procedure in the VFL procedure. The ML model provisioning procedure and the ML model training procedure may include operations 1301 to 1304, and the ML model inference procedure may include operation 1305.

In operation 1301, a VFL server (e.g., an NWDAF or ASF) may provision an initial ML model for VFL to VFL client(s) (or VFL client NF(s)) such as AF(s) and/or other NWDAF(s). The VFL server may own the entire ML model for VFL. Depending on the embodiment, the ownership of the entire ML model may vary depending on scenarios, and the relevant procedures may be updated accordingly.

In operation 1302, the VFL server (e.g., the NWDAF or ASF) may provision an initial ML model used for training to AF(s) and/or other NWDAF(s) selected as the VFL clients (or the VFL client NFs).

In operations 1303a and 1303b, the VFL clients (e.g., the AF(s) and/or other NWDAF(s)) may perform ML model training based on the provisioned initial ML model in operation 1302 and a local dataset.

In operation 1304, the VFL clients (e.g., the AF(s) and/or other NWDAF(s)) may transmit intermediate results to the VFL server (e.g., the NWDAF or ASF).

In operation 1305, the ML model inference may be performed collaboratively with the VFL server and the VFL clients (or the VFL client NFs).

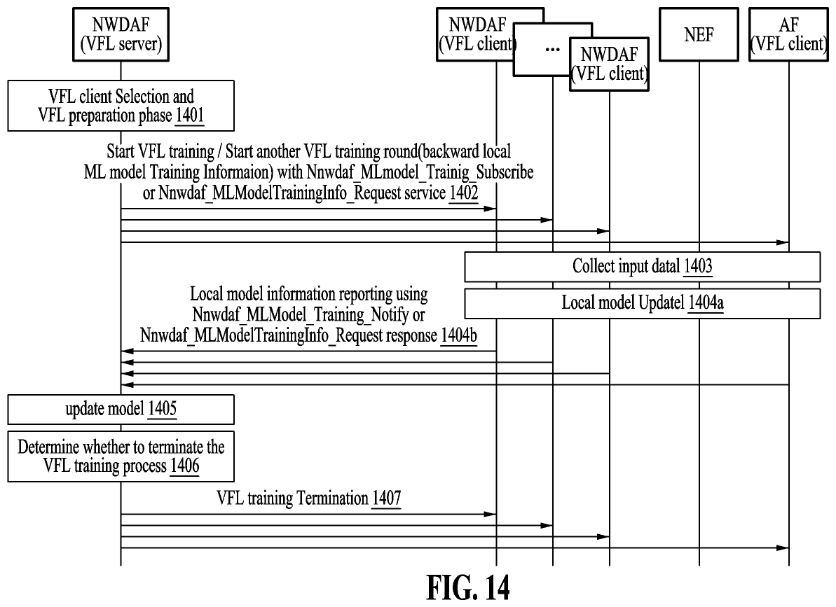

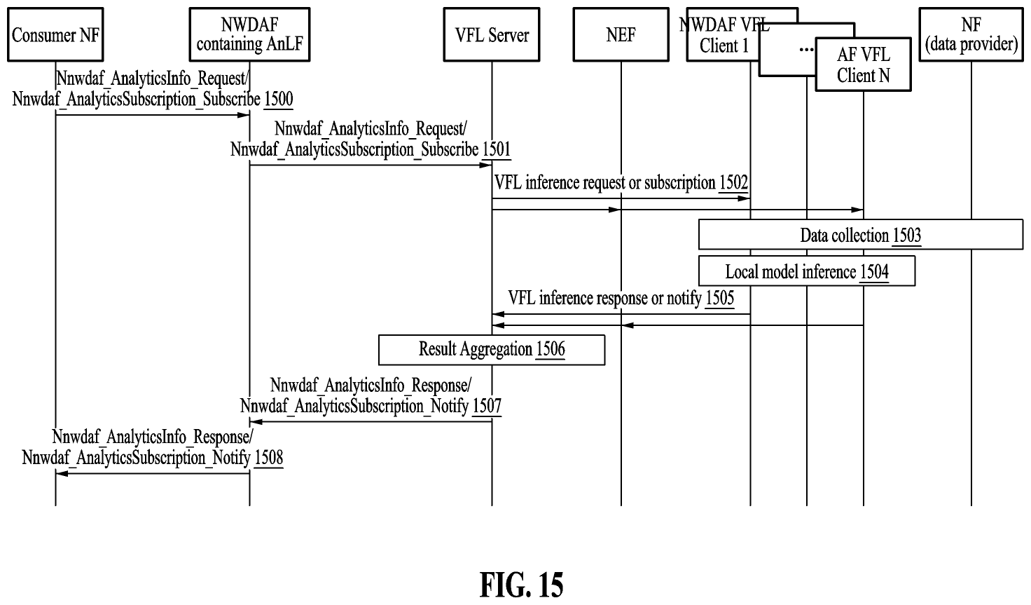

FIG. 14 is a diagram illustrating a VFL procedure according to an embodiment.

FIG. 14 illustrates a training procedure for VFL when an NWDAF serves as a VFL server.

In operation 1401, a VFL server (e.g., an NWDAF) may determine VFL clients that participate in the VFL client discovery and preparation procedures described with reference to FIGS. 11 and 12.

The VFL server may determine to perform VFL training based on the internal trigger or local configuration by an 5GC NF.

Operations 1402 to 1406 may be repeated until the training condition is reached.

In operation 1402, to start VFL training, the VFL server may allocate a VFL correlation ID. The VFL server may transmit a request to start VFL training to each of the selected VFL clients. For example, the VFL server may transmit Nnwdaf_MLModelTraining_Subscribe or Nnwdaf_MLModelTrainingInfo_Request to the selected VFL client NWDAFs, and transmit Naf_VFLTraining_Subscribe or Naf_VFLTrainingInfo_Request to the selected VFL client AF(s).

The request to start VFL training may include the VFL correlation ID and the VFL capability type (e.g., a VFL client).

If the VFL procedure continues in subsequent iterations, the VFL server may transmit a request for a new VFL training iteration including backward local ML model training information to each VFL client for next round of VFL training.

In operation 1403, each VFL client may collect its local data using the current mechanism if the VFL client has no local data already available.

In operations 1404a and 1404b, during the VFL training procedure, each VFL client may further train a local ML model associated with the same VFL correlation ID based on the data (e.g., their own collected and/or available local data) and backward local ML model training information (e.g., distributed by the VFL server in the previous training iteration), and compute and report client intermediate training results of the local ML model to the VFL server.

The report may include sample IDs corresponding to the intermediate training results.

When the client reports the client intermediate training results, the report may include the corresponding VFL correlation ID.

In operation 1405, the VFL server may collect the local data and generate its own local intermediate training results. The VFL server may compute backward local ML model training information (e.g., gradient information and/or loss information) based on the client intermediate training results (e.g., received in operation 1404), its own local intermediate results, and a label. The backward local ML model training information may be used for updating the models of VFL clients. Separate backward local ML model training information may be computed for different VFL clients, respectively.

The VFL server may also compute an ML model metric (e.g., ML model accuracy) based on the intermediate training results (e.g., all the intermediate training results received from VFL clients) and the label.

In operation 1406, the VFL server may evaluate whether the VFL Training process is converged, (e.g., the convergence of a loss function or loss value, whether the pre-set iteration number is reached, etc.). If not, the VFL server may determine another round of VFL training is required and repeat operations 1402 to 1406. If yes, the VFL server may determine the VFL training is completed. In this case, the VFL server may terminate the current VFL training process via operation 1407.

VFL training termination may be determined as follows.

The VFL server may transmit a VFL status report to a consumer based on a consumer request. The status report may include a model metric (e.g., ML model accuracy).

The consumer may determine whether the current model can fulfil the requirements (e.g., the ML model metric is satisfactory for the consumer) and determine to stop or continue the training process. The consumer may continue the training process or stop the training process.

Based on the subscription request transmitted from the consumer, the VFL server may update or terminate the current VFL training process.

The VFL server may determine with which VFL client(s) to continue VFL. If VFL clients are changed, the VFL server may provide sample ID(s) to the VFL clients (e.g., changed VFL clients).

In operation 1407, the VFL server may transmit a VFL training termination message to the VFL clients if the VFL server determines to terminate the VFL training process. The VFL server and each VFL client may store the VFL correlation ID and latest information related to their locally trained models.

The VFL correlation ID may be used later for inference.

If an untrusted AF is involved in VFL clients, a message between an NWDAF acting as a VFL server and the untrusted AF may be transmitted and received via an NEF.

FIG. 15 is a diagram illustrating a VFL procedure according to an embodiment.

FIG. 15 illustrates an inference procedure for VFL when an NWDAF serves as a VFL server.

In operation 1500, for an NWDAF as a VFL server, an analytics consumer NF may transmit an analytics request/subscribe (e.g., including analytics ID, target of analytics reporting=UE ID, and/or analytics reporting information=analytics target period) to an NWDAF including an AnLF by invoking Nnwdaf_AnalyticsInfo_Request or Nnwdaf_AnalyticsSubscription_Subscribe.

In operation 1501, if the NWDAF including the AnLF can be a VFL server to generate VFL inference results for the requested analytics ID, then operation 15011 may be skipped.

If the NWDAF including the AnLF cannot generate the analytics output, the NWDAF including the AnLF may determine a VFL server for the requested analytics and transmit a subscription request to the VFL server (e.g., the VFL server NWDAF) using Nnwdaf_AnalyticsInfo_Request or Nnwdaf_AnalyticsSubscription_Subscribe. Nnwdaf_AnalyticsInfo_Request or Nnwdaf_AnalyticsSubscription_Subscribe may include analytics ID and target of analytics reporting (e.g., UE IDs).

In operation 1502, based on the information received in operation 1500 or 1501, the VFL server may determine to initiate the VFL inference procedure with VFL clients. The VFL server may select VFL clients using information stored in the VFL training process. The VFL server may select some or no clients depending on their contribution to the training results and the current status of the client (e.g., VFL client).

If the VFL server is an NWDAF and the VFL clients are NWDAFs, the VFL server NWDAF may transmit a VFL inference request/subscription including the UE IDs and VFL correlation ID to the VFL clients. The corresponding ID may indicate the VFL client that is to use a previously well-trained VFL local model associated with the ID.

When the VFL server is an NWDAF and the VFL clients are AFs, the VFL server NWDAF may transmit a VFL inference request/subscription including the UE IDs and the VFL correlation ID to the VFL clients. The corresponding ID may indicate the VFL client that is to use a previously well-trained VFL local model associated with the ID. If an AF is untrusted, the VFL server NWDAF may transmit the request to an NEF, and the NEF may forward the request to the untrusted AF.

In operation 1503, each VFL client may collect its local data using the current mechanism if the VFL client does not have local data already available.

In operation 1504, based on the VFL correlation ID, each VFL client may determine the VFL local model to generate intermediate local inference results.

In operation 1505, the VFL client may transmit the client intermediate local inference results to the VFL server. At this time, the VFL client may transmit the VFL correlation ID to the VFL server along with the client intermediate local inference results. The VFL correlation ID may be included in the transmission of the client intermediate local inference results.

The intermediate local inference results, which are transmitted from the VFL client to the VFL server during the VFL inference process, may be the information for the VFL server to combine and generate the VFL inference results.

If the VFL server uses an inference subscription in operation 1502, operation 1505 may be repeated.

In operation 1506, the VFL server may collect its local data and generate the intermediate local inference results. The VFL server may combine all the intermediate local inference results to generate the VFL inference results based on the VFL correlation ID. The VFL server may consider the participation of each VFL client during the ML training process and the importance of the intermediate results when generating the combined inference output. In operation 1507, when an NWDAF is a VFL server, operation 1507 may be skipped.

In operation 1508, the NWDAF including the AnLF may provide the analytics output to the analytics consumer NF based on the VFL inference results by means of either Nnwdaf_AnalyticsInfo_Response or Nnwdaf_AnalyticsSubscription_Notify, depending on the service used in operation 1500.

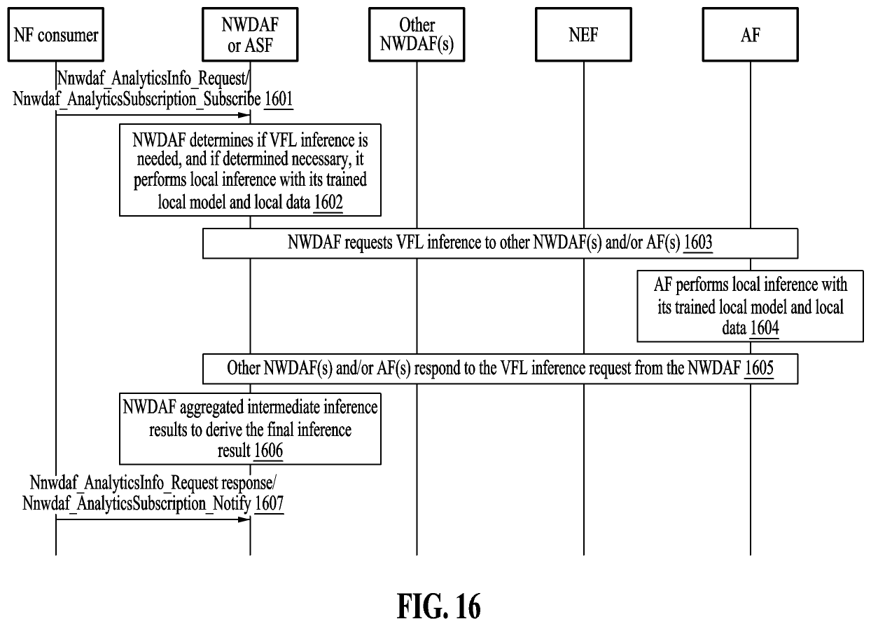

FIG. 16 is a diagram illustrating a VFL procedure according to an embodiment.

FIG. 16 illustrates an ML model inference procedure for VFL when an NWDAF or ASF serves as a VFL server.

In operation 1601, a consumer NF may transmit an analytics request/subscribe to a VFL server (e.g., an NWDAF) by invoking Nnwdaf_AnalyticsInfo_Request or Nnwdaf_AnalyticsSubscription_Subscribe. The analytics request/subscribe may include analytics ID=service experience, target of analytics reporting=any UE, and analytics filter information. Otherwise, the consumer NF may transmit a request or subscription to the NWDAF through an ASF, a new AI/ML supporting NF. In the latter case, new service operations may be needed.

The consumer NF may not need to know whether the NWDAF supports VFL. Instead, the NWDAF receiving the request from the consumer NF may determine if VFL inference is needed.

In operation 1602, the VFL server (e.g., the NWDAF) may determine if VFL inference is needed, and if determined necessary, it may perform local inference with its trained local model and local data.

In operation 1603, The VFL server (e.g., the NWDAF) may request VFL inference to VFL clients (e.g., other NWDAF(s) and/or AF(s)).

In operation 1604, the VFL clients (e.g., other NWDAF(s) and/or AF(s)) may perform local inference with their local model and local data.

In operation 1605, the VFL clients (e.g., other NWDAF(s) and/or AF(s)) may respond to the VFL inference results from the VFL server (e.g., the NWDAF).

In operation 1606, the VFL server (e.g., the NWDAF) may aggregate intermediate inference results from the VFL clients (e.g., other NWDAF(s) and/or AF(s)) and finally derive the final inference results.

In operation 1607, the VFL server (e.g., the NWDAF) may provide the data analytics to the consumer NF by means of either an Nnwdaf_AnalyticsInfo_Request response or Nnwdaf_AnalyticsSubscription_Notify, depending on the service used in operation 1601.

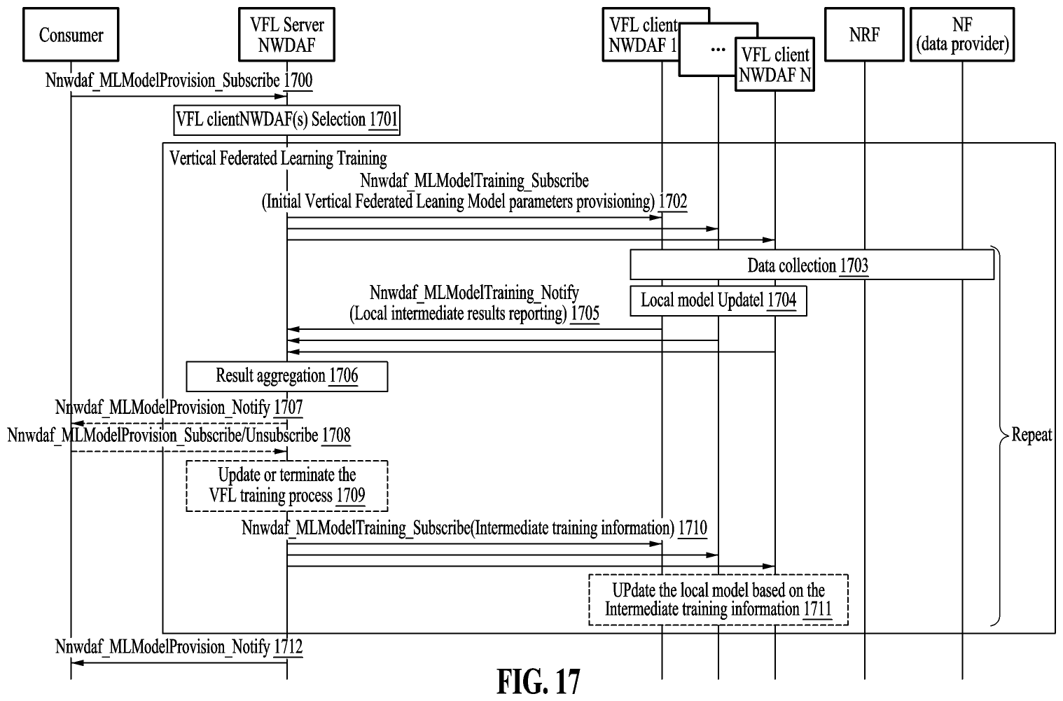

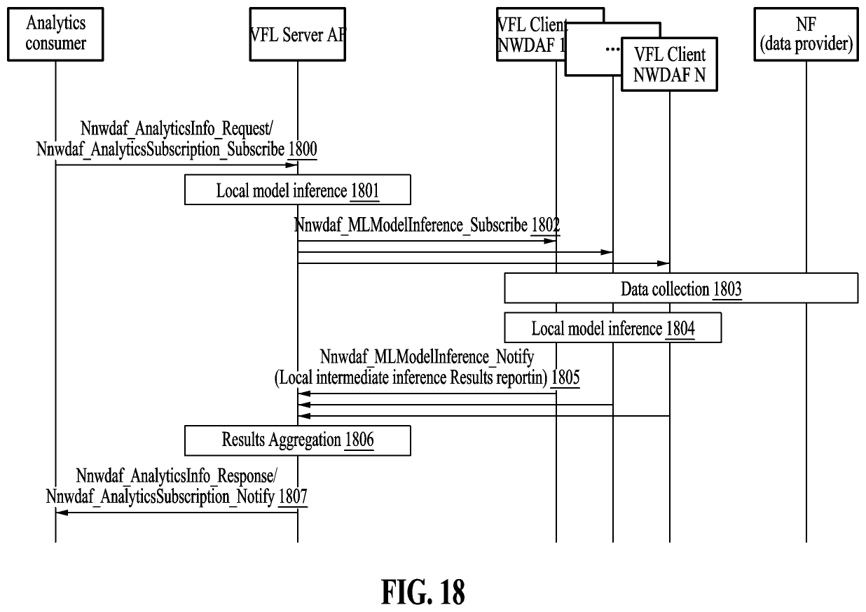

FIGS. 17 and 18 illustrate a VFL scenario where an NWDAF is a VFL server while other NWDAF are VFL clients.

FIG. 17 is a diagram illustrating a VFL procedure according to an embodiment.

FIG. 17 illustrates a training procedure for a VFL scenario between NWDAFs in a single PLMN.

In operation 1700, a consumer (e.g., an NWDAF including an AnLF) may transmit a subscription request to a VFL server NWDAF to discover an ML model. The consumer may transmit the subscription request to the VFL server NWDAF using Nnwdaf_MLModelProvision. The subscription request (e.g., Nnwdaf_MLModelProvision_Subscribe) may include analytics IDs and desired ML model metric (e.g., ML model accuracy).

The ML model accuracy threshold may be used to indicate the target ML model accuracy of the training process, and the VFL server NWDAF may stop the training process when the ML model accuracy threshold is achieved during the training process.

If the consumer (e.g., the NWDAF including the AnLF) provides the time when the ML model is needed, the VFL server NWDAF may take this information into account to determine the maximum response time for its VFL client NWDAF(s).

In operation 1701, the VFL server NWDAF may select NWDAF(s) including an MTLF (e.g., VFL client NWDAF(s)) according to the discovery and preparation (e.g., including sample and feature alignment) procedures shown in FIGS. 11 and 12.

In operation 1702, the VFL server NWDAF may transmit Nnwdaf_MLModelTraining_Subscribe or Nnwdaf_MLModelTrainingInfo_Request to the selected NWDAF(s) including an MTLF (e.g., the VFL client NWDAF(s)). These NWDAF(s) (e.g., the VFL client NWDAF(s)) may participate in VFL to perform local model training, and derive local intermediate results based on input parameters in the request from the VFL server NWDAF. The request (e.g., Nnwdaf_MLModelTraining_Subscribe or Nnwdaf_MLModelTrainingInfo_Request) may include interested UE IDs to indicate target samples for training and a feature profile to indicate which features are used for training, the desired ML model metric, an initial ML model to configure the local model for the VFL client NWDAF(s), and VFL model correlation IDs used to correlate the training processes at the VFL client NWADF(s) during the training and subsequent inference processes, and also include the maximum response time. The VFL client NWDAF may report the local intermediate results to the VFL server NWDAF before the maximum response time elapses.

In operation 1703, each VFL client NWDAF may collect its local data using the current mechanism if the VFL client NWDAF has no local data already available.

In operation 1704, during the VFL training procedure, each VFL client NWDAF may train the ML model based on its local data to report the local intermediate results to the VFL server NWDAF.

In operation 1705, each VFL client NWDAF may transmit an Nnwdaf_MLModelTraining_Notify or Nnwdaf_MLModelTrainingInfo_Request response to the VFL server NWDAF. The Nnwdaf_MLModelTraining_Notify or Nnwdaf_MLModelTrainingInfo_Request response may include the local intermediate results and the VFL model correlation ID.

The local intermediate results, which are transmitted from the VFL client NWDAF(s) to the VFL server NWDAF during the VFL training process, may be the information for the VFL server NWDAF to aggregate the local intermediate training results and generate intermediate training information (e.g., gradient information and loss information) for updating its local model and local models at each VFL client NWDAF.

If the VFL client NWDAF is not able to complete the training of the local VFL Model within the maximum response time provided by the VFL server NWDAF, the VFL client NWDAF may transmit a delay event notification before the maximum response time elapses. The delay event notification may include a delay event indication, an optional cause code (e.g., a local ML model training failure, and more time necessary for local ML model training), and the expected time to complete the training.

In operation 1706, the VFL server NWDAF may aggregate all the local intermediate training results to generate the intermediate training information (e.g., gradient information and loss information) based on the VFL model correlation ID and the label stored in the VFL server NWDAF, and update its local model and the local models at each VFL client NWDAF.

If the VFL server NWDAF provides the maximum response time for the VFL client NWDAF(s) to provide the local intermediate results in operation 1702, the VFL server NWDAF may determine whether to wait until the VFL client NWDAF(s), which have not yet provided their local intermediate results, provide the local intermediate results within a new maximum response time or to aggregate only the discovered local intermediate results to update its local model and the local models at each VFL client NWDAF. The VFL server NWDAF may make this decision, considering a notification/response from the VFL client NWDAF or, if a notification is not received, based on the local configuration.

In operation 1707, based on the consumer request in operation 1700, the VFL server NWDAF may transmit an Nnwdaf_MLModelProvision_Notify message to update the VFL training status to the consumer periodically or dynamically when some predetermined status is achieved (e.g., the ML model accuracy threshold is achieved, or the training time expires).

In operation 1708, the consumer may determine whether the current model can fulfil the requirements. For example, the consumer may determine whether the ML model metric value is satisfactory for the consumer and determine to stop or continue the training process. The consumer may re-invoke the Nnwdaf_MLModelProvision_Subscribe service operation as used in operation 1700 to continue the training process or may invoke the Nnwdaf_MLModelProvision_Unsubscribe service operation to stop the training process.

In operation 1709, based on the subscription request transmitted from the consumer in operation 1708, the VFL server NWDAF may update or terminate the current FL training process.

If the VFL Server NWDAF receives a request to stop the VFL training process, operations 1710 and 1711 may be skipped.

In operation 1710, if the VFL procedure continues, the VFL server NWDAF may transmit Nnwdaf_MLModelTraining_Subscribe or Nnwdaf_MLModelTrainingInfo_Request to the selected VFL client NWDAF(s) for the next round of VFL training. Nnwdaf_MLModelTraining_Subscribe or Nnwdaf_MLModelTrainingInfo_Request may include the intermediate training information and the VFL model correlation ID.

In operation 1711, each VFL client NWDAF may update its own ML model based on the intermediate training information distributed by the VFL server NWDAF in operation 1710.

Operations 1703 to 1708 may be repeated until the training termination condition (e.g., the maximum number of iterations, or the result of loss function being lower than a threshold) is reached.

When the VFL training procedure is complete, the VFL server NWDAF may request the VFL client NWDAF(s) to terminate the VFL procedure. The request may include a cause code that the VFL process has finished. For example, the VFL server NWDAF may invoke an Nnwdaf_MLModelTraining_Unsubscribe service with the cause code that the VFL process has finished. Then the VFL client NWDAF(s) may terminate the local model training.

In operation 1712, after the training process is complete, the VFL server NWDAF may transmit Nnwdaf_MLModelProvision_Notify that includes the model training completion indication to the consumer.

FIG. 18 is a diagram illustrating a VFL procedure according to an embodiment.

FIG. 18 illustrates an inference procedure for a VFL scenario between NWDAFs in a single PLMN.

In operation 1800, an analytics consumer may transmit an analytics subscription or request to a VFL server NWDAF to discover analytics results, using Nnwdaf_AnalyticsSubscription_Subscribe or Nnwdaf_AnalyticsInfo_Request. The analytics subscription or request may include analytics ID (e.g., service experience), target of analytics reporting (e.g., UE IDs), analytics filter information (e.g., application ID, S-NSSAI, DNN, area of interest, etc.), and analytics reporting information (e.g., analytics target period).

In operation 1801, based on the requested analytics ID, the VFL server NWDAF may determine that VFL inference is required among multiple NWDAFs and then check the associated VFL model correlation ID.

In operation 1802, the VFL server NWDAF may transmit a VFL inference request to the VFL client NWDAFs (e.g., which are selected during the training procedure). The VFL inference request may include the UE IDs and VFL model correlation ID. The UE IDs may be used for inference, and the VFL model correlation ID may be intended to identify the associated ML model(s) assigned to the VFL client NWADF(s) during the training.

In operation 1803, each VFL client NWDAF may collect its local data using the current mechanism if the VFL client NWDAF has no local data already available.

In operation 1804, based on the received VFL model correlation ID, each VFL client NWDAF may select the local model and perform inference to generate local intermediate inference results.

In operation 1805, each VFL client NWDAF may respond to the VFL server NWDAF including local intermediate inference results and the VFL model correlation ID.

In operation 1806, based on the VFL model correlation ID, the VFL server NWDAF may aggregate all the local intermediate inference results to generate consolidated inference results.

In operation 1807, the VFL server NWDAF may provide analytics results to the analytics consumer, using Nnwdaf_AnalyticsSubscription_Notify or Nnwdaf_AnalyticsInfo_.

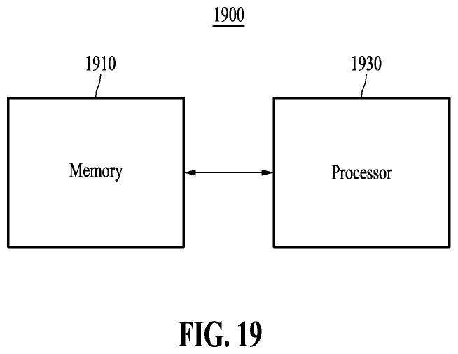

FIG. 19 is a schematic block diagram of a device for supporting VFL according to an embodiment.

Referring to FIG. 19, according to an embodiment, a device 1900 for supporting an NWDAF (e.g., a server device) may be substantially the same as the VFL server and/or the VFL client described with reference to FIGS. 1 to 18. The device 1900 may include a memory 1910, and a processor 1930.

The memory 1910 may store instructions (e.g., a program) executable by the processor 1930. For example, the instructions may include instructions for executing the operation of the processor 1930 and/or the operation of each component of the processor 1930.

The memory 1910 may be implemented as a volatile memory device or a non-volatile memory device. The volatile memory device may be implemented as a dynamic random-access memory (DRAM), a static random-access memory (SRAM), a thyristor RAM (T-RAM), a zero capacitor RAM (Z-RAM), or a twin transistor RAM (TTRAM). The non-volatile memory device may be implemented as an electrically erasable programmable read-only memory (EEPROM), a flash memory, a magnetic RAM (MRAM), a spin-transfer torque (STT)-MRAM, a conductive bridging RAM (CBRAM), a ferroelectric RAM (FeRAM), a phase change RAM (PRAM), a resistive RAM (RRAM), a nanotube RRAM, a polymer RAM (PoRAM), a nano floating gate Memory (NFGM), a holographic memory, a molecular electronic memory device), and/or an insulator resistance change memory.

The processor 1930 may execute computer-readable code (e.g., software) stored in the memory 1910 and instructions triggered by the processor 1930. The processor 1930 may be a hardware-implemented data processing device having a circuit that is physically structured to execute desired operations. The desired operations may include, for example, code or instructions included in a program. The hardware-implemented data processing device may include, for example, a microprocessor, a central processing unit (CPU), a processor core, a multi-core processor, a multiprocessor, an application-specific integrated circuit (ASIC), and a field-programmable gate array (FPGA).

The operation performed by the processor 1930 may be substantially the same as the operation of the VFL server and/or the VFL client described with reference to FIGS. 1 to 18. Accordingly, a further description thereof will be omitted.

The embodiments described herein may be implemented using hardware components, software components, or a combination thereof. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The method according to the above-described embodiments may be recorded in non-transitory computer-readable media including program instructions to implement various operations which may be performed by a computer. The media may also include, alone or in combination with the program instructions, data files, data structures, and the like. The program instructions recorded on the media may be those specially designed and constructed for the purposes of the embodiments, or they may be of the well-known kind and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. The media may be transfer media such as optical lines, metal lines, or waveguides including a carrier wave for transmitting a signal designating the program command and the data construction. Examples of program instructions include both machine code, such as code produced by a compiler, and files containing higher level code that may be executed by the computer using an interpreter.

The described hardware devices may be configured to act as one or more software modules in order to perform the operations of the above-described embodiments, or vice versa.

A number of embodiments have been described above. Nevertheless, it should be understood that various modifications may be made to these embodiments. For example, suitable results may be achieved if the described techniques are performed in a different order, and/or if components in a described system, architecture, device, or circuit are combined in a different manner, and/or replaced or supplemented by other components or their equivalents.

Therefore, other implementations, other embodiments, and equivalents to the claims are also within the scope of the following claims.

1. An operating method of a vertical federated learning (VFL) server, the operating method comprising:
determining to initiate a VFL inference procedure;
selecting a VFL client to perform the VFL inference procedure using information stored in a VFL training process; and
requesting the selected VFL client to perform a VFL inference.

2. The operating method of claim 1, wherein the requesting comprises transmitting a VFL inference request or a VFL inference subscription.

3. The operating method of claim 1, wherein the request comprises a user equipment identifier (UE ID) and a VFL correlation ID.

4. The operating method of claim 3, wherein the UE ID and the VFL correlation ID are intended to represent a VFL client that is to use a pre-trained VFL local model associated with the corresponding ID.

5. The operating method of claim 1, further comprising:
receiving an intermediate local inference result from the selected VFL client; and
generating a VFL inference result using the intermediate local inference result.

6. A vertical federated learning (VFL) server device comprising:
a processor; and
a memory electrically connected to the processor and configured to store instructions executable by the processor,
wherein the instructions, when executed by the processor, cause the server device to perform a plurality of operations, the plurality of operations comprising:
determining to initiate a VFL inference procedure;
selecting a VFL client to perform the VFL inference procedure using information stored in a VFL training process; and
requesting the selected VFL client to perform a VFL inference.

7. The VFL server device of claim 6, wherein the requesting comprises transmitting a VFL inference request or a VFL inference subscription.

8. The VFL server device of claim 6, wherein the request comprises a user equipment identifier (UE ID) and a VFL correlation ID.

9. The VFL server device of claim 8, wherein the UE ID and the VFL correlation ID are intended to represent a VFL client that is to use a pre-trained VFL local model associated with the corresponding ID.

10. The VFL server device of claim 6, wherein the plurality of operations further comprise:
receiving an intermediate local inference result from the selected VFL client; and
generating a VFL inference result using the intermediate local inference result.
